(19) United States
(12) Patent Application Publication
(10) Pub. No.: US 2009/0116858 A1
(43) Pub. Date: May 7, 2009

(54) DEVELOPING DEVICE AND IMAGE FORMING APPARATUS INCLUDING THE SAME

(76) Inventor: Shoji Tomita, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/263,568

(22) Filed: Nov. 3, 2008

(30) Foreign Application Priority Data
Nov. 1, 2007 (JP) P2007-285516

(51) Int. Cl. G03G 15/08; G03G 21/20

(52) U.S. Cl. 399/27; 399/44

(57) ABSTRACT

A developing device capable of adjusting to an appropriate toner density just after replacement of developer regardless of a humidity environment, and an image forming apparatus provided with the same. In a developing device, when developer is replaced, an initial toner density of developer for replacement is set so as to be equal to a toner density in its life or lower, and after replacement of the developer for replacement, a control section determines whether toner replenishment is necessary or not based on a detection value of a humidity sensor prior to a development operation.

### CROSS-REFERENCE TO RELATED APPLICATION

This application claims priority to Japanese Patent Application No. 2007-285516, which was filed on Nov. 1, 2007, the contents of which are incorporated herein by reference in its entirety.

### BACKGROUND OF THE INVENTION

1. Field of the Invention

The present invention relates to a developing device for developing an electrostatic latent image on a surface of a photoreceptor using toner and an image forming apparatus provided with the developing device.

2. Description of the Related Art

An electrophotographic image forming apparatus for forming an image based on an electrophotography method includes, for example, a photoreceptor, and devices for charging, exposure, developing, transfer, fixing, cleaning and charge-removing. A surface of the photoreceptor which is rotationally driven is charged uniformly by the charging device, the charged surface of the photoreceptor is irradiated with laser light by the exposure device, and an electrostatic latent image is formed thereon. Subsequently, the electrostatic latent image on the surface of the photoreceptor is developed using toner by the developing device and a toner image as a visible image is formed on the surface of the photoreceptor. The toner image on the surface of the photoreceptor is transferred to a transfer material by the transfer device, and thereafter undergoes heating and pressing by the fixing device so as to be fixed to the transfer material. Thereby, an image is formed on a recording material. On the other hand, toner remaining on the surface of the photoreceptor without being transferred is removed by the cleaning device and collected in a predetermined collecting portion. After the cleaning, an electric charge remaining on the surface of the photoreceptor is removed by the charge removing device.

As developer for developing the electrostatic latent image on the surface of the photoreceptor, a one-component developer composed of only toner and a two-component developer composed of toner and carrier are used. Since no carrier is used in the one-component developer, an agitating mechanism for mixing toner and carrier uniformly is not necessary. Hence, there is an advantage that the developing device is simplified, however, there is also a disadvantage that an electrical-charge amount of toner is hardly stabilized. The two-component developer needs the agitating mechanism for mixing toner and carrier uniformly. Hence, there is a disadvantage that the developing device is complicated, however, it is excellent in the charge stability of toner and the adaptability to high-speed machines, and therefore the two-component developer is used for a high-speed image forming apparatus and a color image forming apparatus.

In an image forming apparatus using the two component developer, in order to form an image which is excellent in image quality, it is necessary to maintain a toner density in a developing tank of the developing device to be an appropriate density. In order to maintain the toner density in the developing tank to be an appropriate density, in the developing device, for example, a magnetic permeability of the developer is detected as an index of the toner density of the developer, and when a detection value of the magnetic permeability thus detected exceeds a reference value of the magnetic permeability serving as a reference value for judging toner replenishment, the toner density is considered to be less than a predetermined value, then the toner is replenished, resulting that the constant toner density in the two-component developer is maintained. However, charge property of the two-component developer, for example, charging capability of the carrier in the two-component developer, varies as the state of a surface of the carrier is changed due to friction and dirt, thus it is impossible to stably obtain images having a constant image density just by controlling the toner density in the two-component developer to be constant.

In addition, when the two-component developer is used for a long time, the charge property of the two-component developer is deteriorated, and therefore it is necessary to replace the two-component developer after the expiration of the life time. Unexplainable initial fluctuation that the electrical-charge amount of toner is significantly increased and the image density is lowered, is found just after being replaced with a new two-component developer.

Against such initial fluctuation in the charge property of the two-component developer, Japanese Unexamined Patent Publication JP-A 5-249832 discloses a toner density controller wherein a toner density of a new two-component developer is set so as to be higher than a normal toner density used in an image forming apparatus and a toner density reference of toner to be replenished is set se as to be lower than a toner density of initial developer.

According to the toner density controller disclosed in the JP-A 5-249832, it is possible to form images having a constant image density regardless of increase in the electrical-charge amount of toner just after replacement of the developer and the charge property of toner in its life, however, like in the JP-A 5-249832, when the initial toner density is set high and the toner density reference of toner to be replenished is set so as to be lower than the toner density of the initial developer, it is impossible to form images having a constant image density in a high humidity environment. Moreover, when the career is adhered to the photoreceptor drum, there is a risk that not only carrier is wastefully used but also hollow defect is caused in a formed image.

### SUMMARY OF THE INVENTION

An object of the invention is to provide a developing device capable of adjusting a toner density to be optimum just after replacement of developer independent of environment humidity, and an image forming apparatus provided with the same.

The invention provides a developing device, comprising:

a developing tank for accommodating therein developer composed of toner and carrier;

a humidity detecting section for detecting a humidity of surrounding air in a vicinity of the developing tank;

a toner replenishing section for replenishing toner to the developing tank;

an agitating section for agitating developer; and

a determination section for determining whether toner replenishment is necessary or not,

wherein after developer is replaced, the humidity detecting section detects the humidity before starting a development operation,

based on the detected humidity, the determination section determines whether toner replenishment is necessary or not, and

when the determination section determines that toner replenishment is necessary, the toner replenishing section carries out toner replenishment.

According to the invention, after developer is replaced, the humidity detecting section detects the humidity before starting a development operation, and, based on the detected humidity, the determination section determines whether toner replenishment is necessary or not. When the determination section determines that toner replenishment is necessary, the toner replenishing section carries out toner replenishment.

As a result, even when humidity environment surrounding the developing tank varies significantly just after replacement of a two-component developer, it is possible to adjust to a toner density corresponding to the humidity. Hence, it is possible to form images having a constant image density, even when the image forming apparatus is placed in a high humidity environment or in a low humidity environment. Moreover, since it is possible to prevent the carrier from being adhered to a photoreceptor drum, excellent images having no hollow defects can be formed stably.

Furthermore, in the invention, it is preferable that the determination section carries out determination after developer is replaced and developer is agitated by the agitating section.

According to the invention, the determination section carries out determination after developer is replaced and developer is agitated by the agitating section.

When developer for replacement is stood for a long time, the electrical-charge amount of toner decreases significantly and there is a risk that scattering of the toner is caused at the time of agitation, however, after inputting the developer for replacement to the developing device, by agitating for a predetermined time in a state where the toner density is low, that is, a coverage ratio of the carrier by the toner is low, to increase the electrical-charge amount of the toner, it is possible to reduce scattering of the toner. As a result, it is possible to reproduce images having a constant image density more stably.

Furthermore, in the invention, it is preferable that when the determination section determines to replenish toner, the toner replenishing section replenishes toner separately a plurality of times.

According to the invention, when the determination section determines to replenish toner, the toner replenishing section replenishes toner separately a plurality of times.

Since toner replenishment is carried out separately a plurality of times, no large amount of toner will be replenished to the developing tank at a time. Thus, it is possible to prevent scattering of the toner because of uncharged toner, and therefore images having a constant image density can be formed more stably.

Furthermore, the invention provides a developing device, comprising:

a developing tank for accommodating therein developer composed of toner and carrier;

a humidity detecting section for detecting a humidity of surrounding air in a vicinity of the developing tank;

a density detecting section for detecting a toner density in the developing tank;

a toner replenishing section for replenishing toner to the developing tank;

an agitating section for agitating developer; and

a determination section for determining whether toner replenishment is necessary or not,

wherein after developer is replaced, the humidity detecting section and the density detecting section detect the humidity and the toner density before starting a development operation,

based on the detected humidity and toner density, the determination section determines whether toner replenishment is necessary or not, and

when the determination section determines that toner replenishment is necessary, the toner replenishing section carries out toner replenishment.

According to the invention, after developer is replaced, the humidity detecting section and the density detecting section detect the humidity and the density before starting a development operation, and, based on the detected humidity and toner density, the determination section determines whether toner replenishment is necessary or not. When the determination section determines that toner replenishment is necessary, the toner replenishing section carries out toner replenishment.

As a result, even when the humidity environment of the two-component developer around the developing device varies, it is possible to adjust to an optimum toner density corresponding to the humidity environment of the two-component developer. Hence, it is possible to form images having a constant image density, even when the image forming apparatus is placed in the high humidity environment or in the low humidity environment. Moreover, since it is possible to prevent the carrier from being adhered to the photoreceptor drum, excellent images having no hollow defects can be formed stably.

Furthermore, in the invention, it is preferable that the density detecting section detects the density after replaced developer is agitated until an electrical-charge amount of toner thereof attains a saturated amount.

According to the invention, the density detecting section detects the density after replaced developer is agitated until an electrical-charge amount of toner thereof attains a saturated amount.

As a result, it is possible to detect the toner density in a state where the electrical-charge amount of toner is stabilized, and therefore a stable density can be detected regardless of stand time of the two-component developer. Hence, it is possible to adjust to an optimum toner density corresponding to the humidity environment of the two-component developer around the developing device, and to form images having a constant image density more stably. Moreover, it is possible to prevent the carrier from being adhered to the photoreceptor drum, and therefore excellent images having no hollow defects can be formed stably.

Furthermore, the invention provides an image forming apparatus provided with the developing device.

Furthermore, according to the invention, since the image forming apparatus is provided with the developing device, it is possible to adjust to an optimum toner density in accordance with the humidity around the developing tank just after replacement of the two-component developer. Hence, it is possible to form images having a constant image density, even when the image forming apparatus is installed in the high humidity environment or in the low humidity environment. Moreover, it is possible to prevent the carrier from being adhered to the photoreceptor drum, and therefore excellent images having no hollow defects can be formed stably.

### BRIEF DESCRIPTION OF THE DRAWINGS

Other and further objects, features, and advantages of the invention will be more explicit from the following detailed description taken with reference to the drawings.

FIG. 1 is a schematic view schematically showing the structure of an image forming apparatus in accordance with a first embodiment of the invention;

FIG. 2 is a schematic view showing the structure of the developing device according to the embodiment;

FIG. 3 is a flowchart showing procedure of initial toner density correction processing based on a detection value of the humidity sensor in the developing device;

FIG. 4 is a flowchart showing procedure of initial toner density correction processing based on detection values of the humidity sensor and the magnetic permeability sensor in the developing device;

FIG. 5 is a graph showing a relation between an atmosphere humidity and a detection value (output voltage) of the magnetic permeability sensor in a case where the toner density of the developer is constant;

FIG. 6 is a graph showing a relation between a toner density of the developer in the developing tank and a detection value (magnetic permeability detection value) of the magnetic permeability sensor;

FIG. 7 is a view showing an example of an environment correction table;

FIG. 8 is a view showing an example of an initial toner density correction table; and

FIG. 9 is a graph showing transition of initial toner density correction amounts in each humidity area.

### DETAILED DESCRIPTION

Now referring to the drawings, preferred embodiments of the invention will be hereinafter described in detail. Following embodiment is not intended to limit the technical scope of the invention but is described only as an example.

<Image Forming Apparatus>

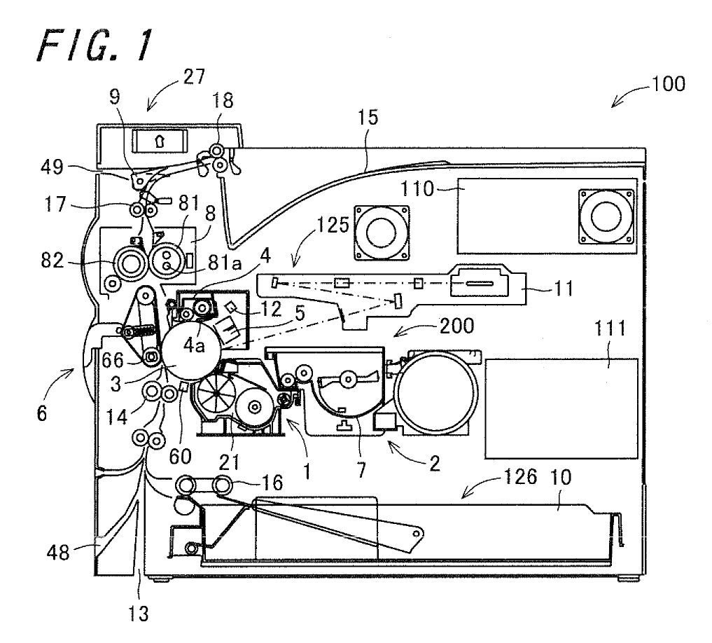

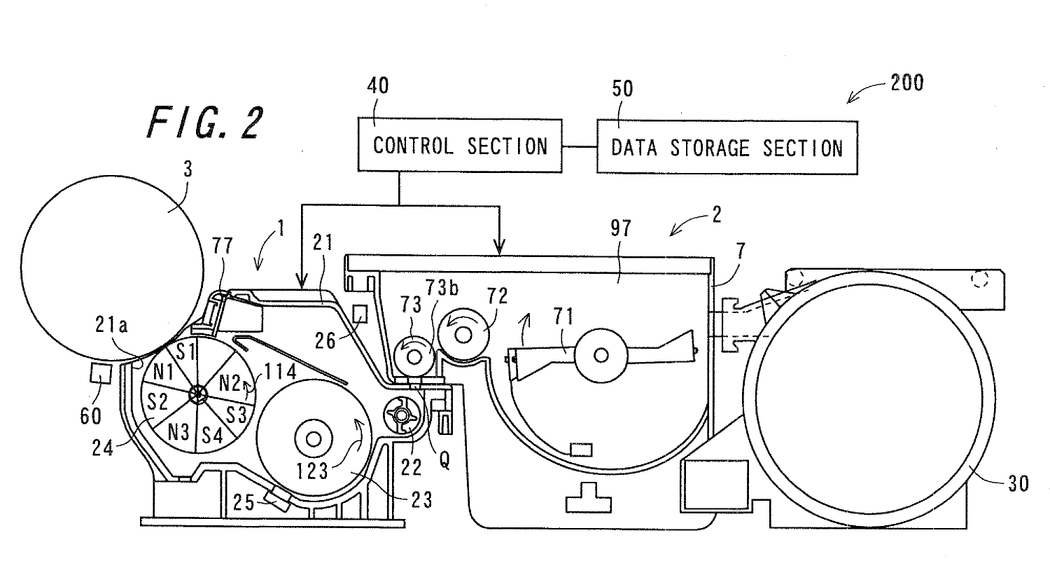

FIG. 1 is a schematic view graphically showing the structure of an image forming apparatus 100 in accordance with a first embodiment of the invention. The image forming apparatus 100 shown in FIG. 1 has same structure as that of a conventional image forming apparatus, except for including a developing device 200 of the embodiment shown in FIG. 2, and forms a monochrome image on a recording medium such as a recording paper in accordance with, for example, image information transmitted through a network from an external device such as a personal computer, a digital camera and a DVD recorder, and image information read by a scanner apparatus (not shown) in the mage forming apparatus 100. The image forming apparatus 100 includes an image forming section 125, a recording medium feeding section 126, an image fixing section 27, a control unit 110, and a power supply device 111.

The image forming section 125 includes a photoreceptor drum 3, a charging section 5, an exposure unit 11, a developing device 200, a transfer section 6, a cleaning unit 4, and a charge removing section 12. The charging section 5, the exposure unit 11, the developing device 200, the transfer section 6, the cleaning unit 4, and the charge removing section 12 are arranged around the photoreceptor drum 3 in that order. The photoreceptor drum 3 is a roller like member which is provided so as to be driven rotatably around an axis by a driving section (not shown). As the photoreceptor drum 3, for example, a roller like member including a metal core and a photosensitive layer formed on a surface of the metal core is used. The metal core is made of a metal such as aluminum, stainless steel or the like. As the photosensitive layer, for example, a laminated body of a resin layer containing a charge generating substance and a resin layer containing a charge transporting layer is applicable. On the photosensitive layer, an electrostatic latent image and further a toner image are formed as will be described later. The charging section 5 charges the surface of the photoreceptor drum 3 at a predetermined polarity and potential. As the charging section 5, for example, a contact type charging device and a non-contact type charging device s such as a charger type charging device, a roller type charging device, and a brush type charging device, are applicable.

The exposure unit 11 irradiates the surface of the photoreceptor drum 3 in the charged state by the charging section 5 with a signal light based on image information to form an electrostatic latent image on the surface of the photoreceptor drum 3. As the exposure unit 11, for example, a laser scanning unit including a laser irradiating section such as a semiconductor laser and a reflection mirror is applicable. A developing section 1 provided in the developing device 200 supplies toner to the electrostatic latent image on the surface of the photoreceptor drum 3 to develop, followed by forming a toner image as a visible image. The cleaning unit 4 removes and collects residual toner on the surface of the photoreceptor drum 3 after transferring the toner image to a recording medium. The transfer section 6 includes a transfer roller 66 and a power supply (not shown). The transfer roller 66 is a roller like member which is in pressure-contact with the surface of the photoreceptor drum 3 and is provided rotatably. The pressure-contact portion of the transfer roller 66 and the photoreceptor drum 3 is a transfer nip portion. A transfer bias voltage is applied to the transfer roller 66 by the power supply. According to the transfer section 6, the transfer bias voltage is applied from the transfer roller 66 side of the recording medium to charge the recording medium, and a pressure is applied to the recording medium by the transfer roller 66, and thereby the toner image on the surface of the photoreceptor drum 3 is transferred to the recording medium. Note that, in synchronization with the exposure by the exposure unit 11, the recording medium is delivered from a recording medium feeding section 126, which will be described later, to the transfer nip portion. The cleaning unit 4 includes a cleaning blade 4a. The cleaning blade 4a is a plate like member which is made of, for example, an elastic material and is provided so as to abut against the surface of the photoreceptor drum 3. The cleaning blade 4a removes toner, paper powder and the like that are remained on the surface of the photoreceptor drum 3 after transferring the toner image to the recording medium. The charge removing section 12 includes a charge removing lamp and the like, and removes an electric charge on the surface of the photoreceptor drum 3 after cleaning.

In the image forming section 125, the surface of the photoreceptor drum 3 is made in the charged state by the charging section 5, a signal light based on image information is irradiated thereto from the exposure unit 11, and thereby an electrostatic latent image is formed on the surface of the photoreceptor drum 3. Toner is supplied to the electrostatic latent image from the developing device 200 to form a toner image, and the toner image is transferred to the recording medium by the transfer section 6. The surface of the photoreceptor drum 3 after the toner transfer is subjected to the removal of residual toner and the like by the cleaning unit 4 and the removal of an electric charge by the charge removing section 12, and thereby the surface is cleaned. The sequence of operations is repeatedly carried out so as to form an image.

The recording medium feeding section 126 includes a recording medium tray 10, a pickup roller 16, and a registration roller 14. The recording medium tray 10 is a tray for storing recording mediums such as plain paper, coat paper, color copy paper, and OHP films. The recording mediums are supplemented to the recording medium tray 10 by drawing the recording medium tray 10 on the frontal side of the image forming apparatus 100 (the operation side). The recording mediums stored in the recording medium tray 10 are separated one by one by the pickup roller 16, and are delivered to the registration roller 14 one by one. The recording mediums are delivered sequentially to the transfer nip portion by the registration roller 14 in synchronization with the exposure to the surface of the photoreceptor drum 3 by the exposure unit 11 in the image forming section 125. According to the recording medium feeding section 126, the recording mediums stored in the recording medium tray 10 are fed to the developing device 200 through the pickup roller 16 and the registration roller 14.

The image fixing section 27 includes a fixing device 8, a transport roller 17, a switch gate 9, a reversing roller 18, and an onboard tray 15. The fixing device 8 includes a fixing roller 81 and a press roller 82. The fixing roller 81 is a roller like member which is provided so as to be driven rotatably by the driving section (not shown), and has a heating section 81a therein. As the heating section 81a, a halogen lamp, an infrared lamp and the like are applicable. The press roller 82 is a roller like member which is supported rotatably and is provided so as to be in pressure-contact with the fixing roller 81. The pressure-contact portion of the fixing roller 81 and the press roller 82 is a fixing nip portion. A recording medium passing through the fixing nip portion undergoes pressing by the fixing roller 81 and heating by the press roller 82. In the fixing device 8, the recording medium to which a toner image is transferred by the transfer section 6 of the image forming section 12 is delivered to the fixing nip portion to be heated and pressurized, the toner image is fixed to the recording medium, and an image is formed.

The transport roller 17 delivers the image-recorded recording medium, that is, the recording medium on which the image is formed by the fixing device 8 to the switch gate 9. The switch gate 9 switches a delivery path for the image-recorded recording medium. The image-recorded recording medium is transported to any of the reversing roller 18, or a relay transport apparatus (not shown) or a recording medium resupply and transport apparatus (not shown) through the switch gate 9. The reversing roller 18 ejects the image-recorded recording medium to the onboard tray 15. On the other hand, in cases where double-sided image formation or post processing, such as staple processing and punching processing, needs to be carried out, the reversing roller 18 causes a part of the recording medium to be ejected in the direction of the onboard tray 15, in a state where the reversing roller 18 sandwiches the image-recorded recording medium, and then, the reversing roller 18 is rotated reversely to deliver the recording medium toward the relay transport apparatus (not shown) or the recording medium resupply and transport apparatus (not shown) through the switch gate 9 and a transport path 45 which is provided so as to be opened in the side face of the image forming apparatus 100. At this moment, the switch gate 9 changes its position from a position illustrated by solid line to a position illustrated by dotted line. The onboard tray 15 is a tray which is provided on the outside upper part of the image forming apparatus 100 and contains image-recorded recording mediums ejected from the image forming apparatus 100.

According to the image fixing section 27, the toner image is fixed to the recording medium by the fixing device 8, and the image-recorded recording medium is transported to the reversing roller 18 through the transport roller 17 and the switch gate 9, and is ejected to the onboard tray 15 as it is or is led back in the inverse direction by the reversing roller 18 to be delivered to the relay transport apparatus or the recording medium resupply and transport apparatus (not shown) through the switch gate 9.

The control unit 110 is as described in detail in the description for a control section 40.

In addition, transport paths 13 and 48 are provided on the lower face and side face of the image forming apparatus 100. The transport paths 13 and 48 and a transport path 49 are used to transport a recording medium to the outside or the inside of the image forming apparatus 100 at the time of connecting an external device to the image forming apparatus 100.

According to the image forming apparatus 100, an electrostatic latent image is written onto the surface of the photoreceptor drum 3 based on image information inputted to the control unit 110, the electrostatic latent image is developed and transferred to the recording medium as a toner image, and further fixed, followed by being ejected to the onboard tray 15 as it is or being subjected to a post processing step, an another image forming step, and the like.

In spaces above and below the exposure unit 1′, the control unit 110 which contains a circuit substrate for controlling the image forming process, an interface substrate for receiving image data from an external device, the power supply device 111 which supplies electric power to the interface substrate and each of sections for the image formation, and so on, are disposed.

In the embodiment, the image forming apparatus 100 is configured as a printer for forming single-color images, but without limitation thereto, the image forming apparatus 100 is capable of being configured as a printer for forming multi-color images, a multifunctional peripheral, and a facsimile apparatus.

<Developing Device>

FIG. 2 is a schematic view showing the structure of the developing device 200 according to the embodiment. The developing device 200 is incorporated in the image forming apparatus 100 for forming an image by electrophotography, and supplies toner to an electrostatic latent image formed on the surface of the photoreceptor drum 3 to from a toner image. The developing device 200 includes the developing section 1, a toner replenishing section 2, the control section 40, and a data storage section 50. The developing section 1 includes a developing tank 21, a developing roller 24, a supply roller 23, an agitating member 22, and a thickness regulating member 77.

The developing tank 21 is a container like member having an inner space, which contains developer in the inner space. In the embodiment, the developer is a two-component developer including toner and carrier (hereinafter referred to simply as “developer”). Moreover, the developing tank 21 contains and supports the developing roller 24, the supply roller 23, and the agitating member 22 rotatably, and supports the thickness regulating member 77. An opening 21a is formed on one surface of the developing tank facing the photoreceptor drum 23, of surfaces constituting the developing tank 21. The photoreceptor drum 3 and the developing roller 24 are faced to each other via the opening 21a. In addition, an opening Q is formed above the agitating member 22 in a vertical direction on the top of the developing tank in a vertical direction of. The opening Q is a toner receiving port. Being connected to the upper part of the opening Q in the vertical direction, a toner replenishing port (not shown) of a toner hopper 97 in the developing device 200 shown in FIG. 2 is provided so as to be in communication with the opening Q in the vertical direction. In accordance with the state of toner consumption in the developing tank 21, toner is replenished to the developing tank via the opening Q from the toner hopper 97. The toner replenishment from the toner hopper 97 to the developing tank 21 is carried out by rotation of a toner replenishing roller 73. The toner replenishing roller 73 is provided so as to be brought into slide contact with the toner replenishing port at the time of rotation thereof at the upper part of the toner replenishing port in the vertical direction. The developing tank 211 is made of, for example, a synthetic resin, preferably an injection-moldable thermoplastic resin.

The developing roller 24 is a roller like member which is driven rotationally in the direction indicated by the arrow 114 around the axis by the driving section (not shown). The developing roller 24 is provided so as to be disposed near the opening 2a of the developing tank 21 facing the photoreceptor drum 3, to be spaced from the photoreceptor drum 3 by a gap therebetween, and to make the axis of the photoreceptor drum 3 be in parallel with that of the developing roller 24. In the embodiment, the photoreceptor drum 3 and the developing roller 24 have a gap of about 1 mm at the nearest contact position therebetween, that is, a developing nip portion. Moreover, in the embodiment, the photoreceptor drum 3 and the developing roller 24 are provided so as to be spaced from each other by the gap therebetween, but without limitation thereto, both of them may be provided so as to be pressure-contact with each other. The developing roller 24 is rotationally driven with a toner layer borne on the surface thereof, and in the developing nip portion, toner is supplied to an electrostatic latent image on the surface of the photoreceptor drum 3 to develop, followed by forming a toner image. When the toner is delivered from the developing roller 24 to the photoreceptor drum 3, a developing bias voltage is applied from the power supply (not shown) to the developing roller 24.

The supply roller 23 is a roller like member which is provided so as to face the photoreceptor drum 3 through the developing roller 24. The supply roller 23 is rotationally driven in the direction indicated by the arrow 123 around the axis by the driving section (not shown). By the rotational driving, the supply roller 23 slides toner or toner and carrier, which are accommodated in the inner space of the developing tank 21, to charge the toner, and the toner is delivered to the surrounding of the developing roller 24.

The agitating member 22 is a screw member driven rotationally around the axis by the driving portion (not shown), which is provided at a position facing the developing roller 24 through the supply roller 23 and below the opening Q in the vertical direction. By the rotational driving, the agitating member 22 mixes the toner that is supplied to the developing tank 21 through the opening Q as the toner receiving port and the toner that is originally present in the developing tank 21 uniformly, and delivers uniformly mixed toner to the surrounding of the supply roller 23.

The thickness regulating member 77 is a plate like member which is provided such that one end in a shorter direction is supported by the developing tank 21 and the other end is a free end part so as to be spaced from the surface of the developing roller 24 by a gap therebetween. In the embodiment, there is about 0.9 mm of space between the other end of the thickness regulating member 77 and the developing roller 24. The thickness regulating member 77 adjusts a layer thickness of the developer borne on the surface of the developing roller 24 so as to be a predetermined value. The thickness regulating member 77 is made of, for example, an elastic member. There is no limitation to the elastic member, but examples thereof include a metal, a synthetic resin, and a rubber. Among them, a rubber is preferable in consideration of damage to the photoreceptor drum 3.

A humidity sensor 26 is a humidity detecting section which is provided so as to be spaced from the outer surface at the top of the developing tank 21 in the vertical direction by a gap therebetween, for detecting a humidity around the developing tank 21 as an atmosphere humidity around the developer. The humidity sensor 26 is electrically connected to the control section 40, and the detection result is inputted to the control section 40. As the humidity sensor 26, general humidity sensors are applicable, and, for example, a humidity sensor utilizing change in electrical properties due to adsorption and desorption of the moisture in atmosphere is applicable. Examples of the humidity sensor utilizing change in electrical properties due to adsorption and desorption of the humidity in atmosphere include a wet-and dry-bulb type, a hair type, a crystal-vibration type, a polymer sensor, and a metal oxide sensor. Based on a detection value of the humidity sensor 26, toner is replenished to the developing tank 21. Details thereof. Will be described later. Moreover, in the embodiment, the humidity sensor 26 is provided so as to be spaced from the outer surface of the developing tank 21 by a gap therebetween, but without limitation thereto, the humidity sensor 26 may be provided so as to be brought into contact with the outer surface of the developing tank 21.

A magnetic permeability sensor 25 is a magnetic permeability detecting section which is provided at a position facing the supply roller 23 in the developing tank 21 so as to be in contact with the outer surface of the developing tank 21, for detecting a magnetic permeability as a toner density. When toner (developer) to be measured flows near the sensor, the developer acts as a core so as to vary inductance between coils provided in the magnetic permeability sensor 25. Since the magnitude of the inductance is determined depending on the developer acting as the core or an amount of magnetic powder of magnetic carrier, it is possible to measure the amount of magnetic powder, that is, the toner density by a voltage output from the coils.

The toner replenishing section 2 includes a toner replenishing tank 7, a toner bottle 30, the toner hopper 97, an agitating member 71, a toner delivery roller 72, and the toner replenishing roller 73. The toner bottle 30 reserves toner and is capable of being replaced optionally. The toner hopper 97 reserves toner supplied from the toner bottle 30 temporarily in the toner replenishing tank 7, and when the control section 40 controls an operation of a toner replenishing motor (not shown) to control rotation of the toner replenishing roller 73, an amount of the toner replenished to the developing tank 21 is controlled.

The control section 40 is a determination section which carries out startup, shutdown, rotational driving control of the toner replenishing roller 73 according to the toner density (magnetic permeability detection value), and the like of the developing device 200. The control section 40 is provided with a CPU, a ROM which stores a program to be executed by the CPU, and other peripheral devices, and when the CPU executes the program stored in the ROM, each of following processing is carried out. The data storage section 50 is composed of a SRAM which stores various kinds of parameters and formulas (a coefficient of a formula, etc) used for the processing of the control section 40, and the like. The data storage section 50 is capable of storing parameters necessary for various calculation, or adding and updating new parameters. The data storage section 50 stores a table in which correction coefficients used for calculating a correction amount of an initial toner density are described, which will be described later.

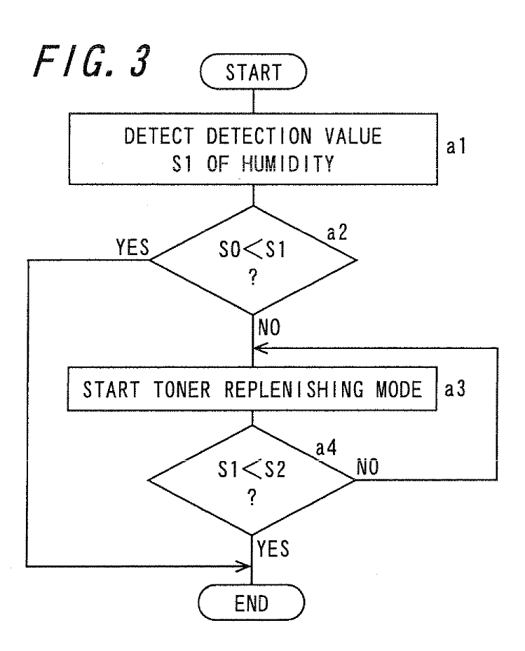

FIG. 3 is a flowchart showing procedure of initial toner density correction processing based on a detection value of the humidity sensor 26 in the developing device 200. In reference to the flowchart shown in FIG. 3, the procedure of initial toner density correction processing after replacement of developer in the developing device 200 shown in FIG. 2 will be described. The processing is carried out by execution of a control program by the control section 40 shown in FIG. 2. Moreover, in the processing, it is preferable that the procedure proceeds to step a1 when the developing tank 21 is provided and thereafter developer for replacement is agitated for a predetermined time. When the developer for replacement is stood for a long time, the electrical-charge amount of the toner decreases significantly, and therefore there is a risk that scattering of the toner is caused at the time of agitation, however, after inputting the developer for replacement to the developing tank 21, by agitating for a predetermined time in a state where the toner density is low, that is, the coverage ratio of the carrier by the toner is low, to increase the electrical-charge amount of the toner, it is possible to reduce scattering of the toner and form images having a constant image density more stably. Hereinafter, a1, a2, and the like represent processing procedure (steps). Note that, the developer for replacement is produced so that its toner density is not more than a toner density in its life in order to set to an appropriate toner density by the toner replenishment. Moreover, the image forming apparatus is provided so as to detect that the developer has been replaced when a service person or the like resets a maintenance counter (returns to zero) after replacement of the developer.

<Step a1>

After replacement of the developer, a detection value S1 of an atmosphere humidity surrounding the developing tank 21 shown in FIG. 2 is detected by the humidity sensor 26 shown in FIG. 2.

<Step a2>

The currently measured detection value S1 of the atmosphere humidity surrounding the developing tank 21 is compared with a previously measured detection value S0 of the atmosphere humidity surrounding the developing tank 21, which is stored in the storage section 50 shown in FIG. 2. When the currently measured detection value S1 of the atmosphere humidity surrounding the developing tank 21 exceeds the previously measured detection value S0 of the atmosphere humidity surrounding the developing tank 21, the processing of initial toner density correction is completed. When the currently measured detection value S1 of the atmosphere humidity surrounding the developing tank 21 is not more than the previously measured detection value S0 of the atmosphere humidity surrounding the developing tank 21, the procedure proceeds to step a3.

<Step a3>

A toner replenishing mode is started to replenish toner. Based on “a correlation conversion table of a detection value S of an atmosphere humidity of developer and a humidity area” and “a conversion table of a humidity area and an amount of replenished toner”, an amount of replenished toner is determined. Although it is possible to replenish the whole amount of toner required to be replenished at a time, it is preferable that the toner is replenished separately a plurality of times, for example, for one third of the toner, so as to increase the toner density of the developer to a desired density in a stepwise fashion. When a large amount of toner is replenished to the developer at a time, scattering of the toner because of uncharged toner can be caused. By carrying out toner replenishment separately a plurality of times, no large amount of toner will be replenished to the developing tank 21 at a time and it is possible to prevent the scattering of the toner because of uncharged toner. Hence, it is possible to form images having a constant image density more stably. The toner replenishment is carried out by controlling rotation time of the toner replenishing roller 73 shown in FIG. 2 with the control section 40.

<Step a4>

At a stage where a small amount toner is replenished, the atmosphere humidity is measured again to confirm whether or not the atmosphere humidity is changed due to an operation by the toner replenishment. When the detection value S1 of the atmosphere humidity of the developer measured at step a1 is less than the currently measured detection value S2 of the atmosphere humidity of the developer, the processing of initial toner density correction is completed. When the detection value S1 of the atmosphere humidity of the developer measured at step a1 is not less than the currently measured detection value S2 of the atmosphere humidity of the developer, the procedure proceeds back to step a3 to replenish the toner. The processing at step a4 is carried out in order to prevent scattering of the toner involving increase in the humidity.

After completing the processing of initial toner density correction, image formation is started to be carried out using the image forming apparatus 100 shown in FIG. 1.

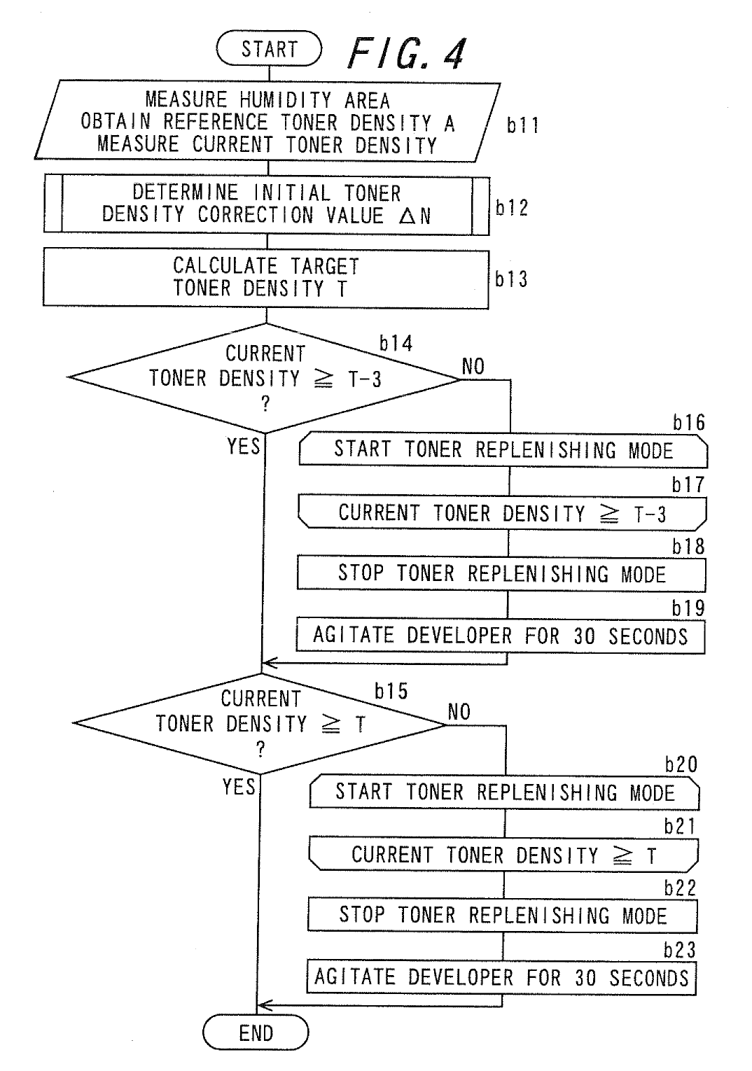

FIG. 4 is a flowchart showing procedure of initial toner density correction processing based on detection values of the humidity sensor 26 and the magnetic permeability sensor 25. In reference to the flowchart shown in FIG. 4, the procedure of initial toner density correction processing after replacement of developer in the developing device 200, which is a second embodiment of the invention, will be described. The processing is carried out by execution of a control program by the control section 40. Moreover, the processing is carried out after the toner bottle 30 shown in FIG. 2 is provided.

It is preferable that a driving system such as the developing roller 24 and the supply roller 23 shown in FIG. 2 is rotationally driven for a predetermine time, for example, twenty times or more, prior to step b11. Thereby, agitation of the developer in the developing tank 21 is started, and a detection value of the magnetic permeability sensor 25 can be detected in a state where the electrical-charge amount of the toner attains a saturated amount. By carrying out detection of the magnetic permeability after agitating the developer for replacement until the electrical-charge amount of the toner of the developer for replacement attains a saturated amount, it is possible to detect the magnetic permeability in a state where the electrical-charge amount of the toner is stable, thus the stable magnetic permeability can be detected regardless of stand time of the developer for replacement. Hence, it is possible to adjust to an optimum toner density corresponding to difference in production lots of developer for replacement and a humidity environment around the developing tank 21, and to form images having a constant image density more stably. It is also possible to prevent carrier from being adhered to the photoreceptor drum 3, and therefore images having no hollow defects can be formed more stably.

With rotational driving for a predetermined time by the developing roller 24, the supply roller 23 and the like, not only the detection value of the magnetic permeability is stabilized but scattering of the toner at the time of toner replenishment which is carried out at a following step, can be reduced. Since the electrical-charge amount of the toner of the developer for replacement which has been stood for a long time decreases significantly, scattering of the toner can be caused at the time of agitation, however, by agitating in a state where the toner density is low, that is, the coverage ratio of the carrier by the toner is low, to increase the electrical-charge amount of the toner, it is possible to reduce scattering of the toner. Hereinafter, b11, b12, and the like represent processing procedure (steps).

<Step b11>

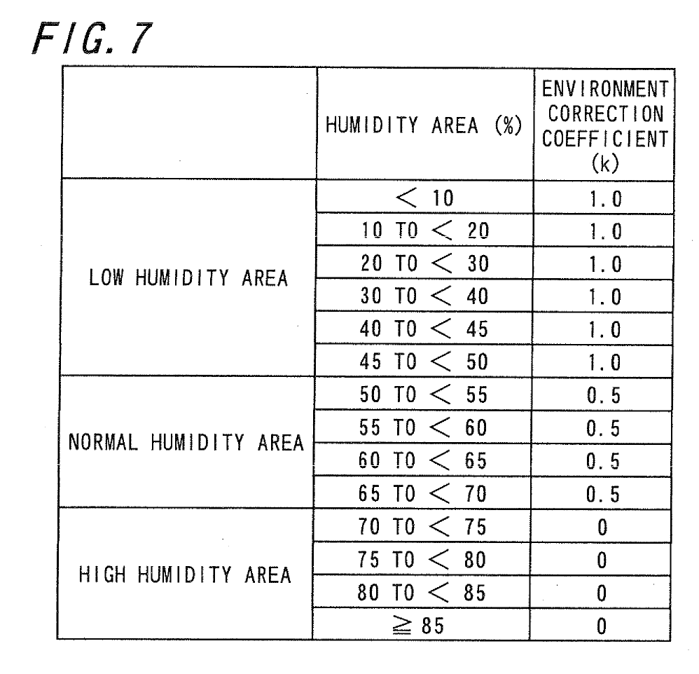

The atmosphere humidity surrounding the developing tank 21 is detected by the humidity sensor 26 shown in FIG. 2, and the humidity area is determined by an environment correction coefficient table shown in FIG. 7. FIG. 7 is an environment correction table to determine a humidity area and an environment correction coefficient k. A reference toner density A is retrieved from the data storage section 50 shown in FIG. 2. The “reference toner density A” is a count value of a reference initial toner density stored in the data storage section 50. A current toner density, that is, a density of the toner in the developing tank 21 is detected by the magnetic permeability sensor 25 shown in FIG. 2.

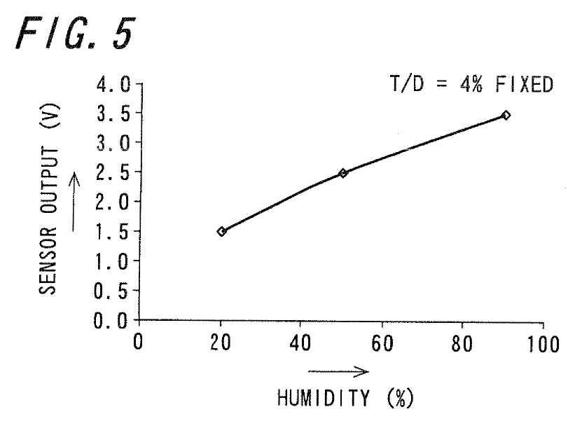

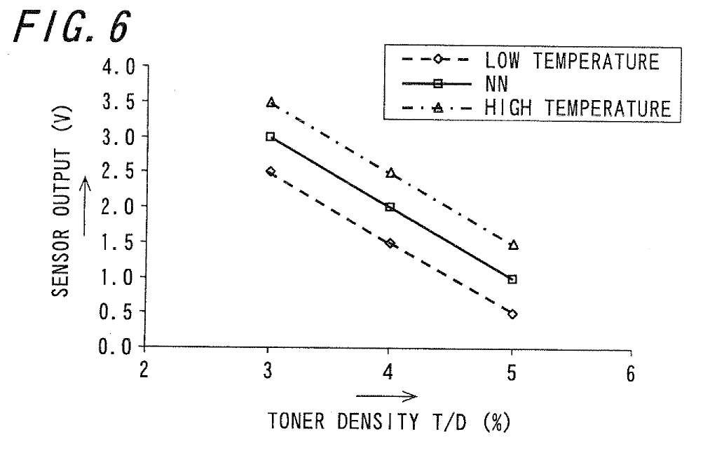

In the magnetic permeability sensor 25 which measures the toner density in the developing tank 21 by detecting the magnetic permeability, a detection value of the magnetic permeability can vary depending on a humidity. FIG. 5 is a graph showing a relation between an atmosphere humidity and a detection value (output voltage) of the magnetic permeability sensor 25 in cases where the toner density of the developer is constant. Here, a weight density of the toner in the developer is 4% by weight. In cases where the atmosphere humidity is high, an amount of the electrical discharge from the developer becomes large, and therefore the electrical-charge amount of the developer decreases and the magnetic permeability detection value increases. Moreover, FIG. 6 is a graph showing a relation between a toner density of the developer in the developing tank 21 and a detection value (magnetic permeability detection value) of the magnetic permeability sensor 25. According to the graph of FIG. 6, sensor output varies in each of environments including a low humidity environment where a temperature is 10° C. and a humidity is 25%, a high humidity environment where a temperature is 30° C. and a humidity is 85%, and a normal humidity (hereinafter referred to also as “NN”) environment where a temperature is 20° C. and a humidity is 65%. In FIG. 6, thick solid line represents a case of the normal humidity environment, the chain line represents a case of the high humidity environment, and the dotted line represents a case of the low humidity environment.

As described above, in the magnetic permeability sensor 25, in cases where the humidity is fixed, the actual toner density and the magnetic permeability detection value are in proportion to each other in a negative direction, however, even though the actual toner density is constant, the magnetic permeability detection value changes according to the change of the humidity environment, thus the magnetic permeability reference value is corrected depending on the humidity environment at step b12.

<Step b12>

An initial toner density correction amount ΔN is determined. The initial toner density correction amount ΔN is obtained by the formula (1):

ΔN=k×N1 (1)

k: an environment correction coefficient

N1: an initial toner density correction value

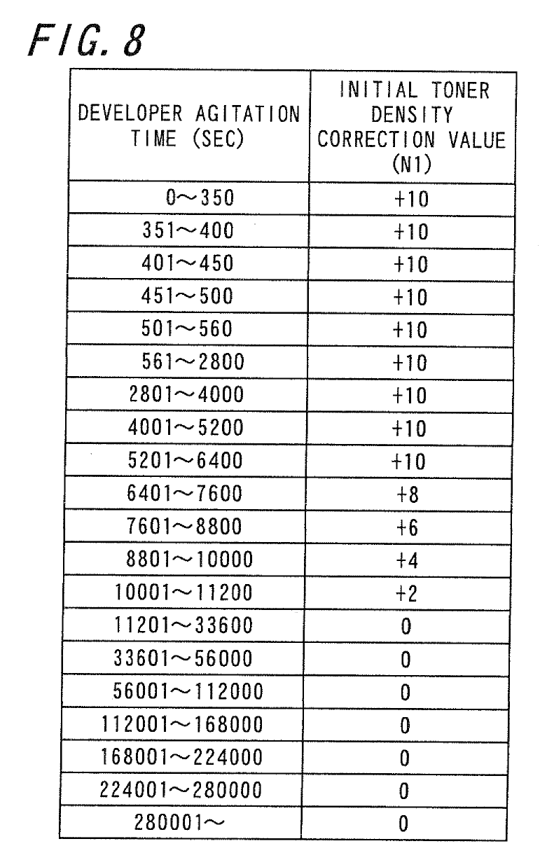

The environment correction coefficient k is obtained from the humidity area measured at step b11 using the environment correction table shown in FIG. 7. The initial toner density correction value N1 is obtained using an initial toner density correction table shown in FIG. 8. FIG. 8 is an initial toner density correction table to obtain the initial toner density correction value N1 by an amount of time that the developer was agitated in the developing tank 21.

<Step b13>

Using the initial toner density correction value N1 calculated at step b12, a target toner density T, that is, a count value of the toner density after correction based on the humidity surrounding the developing tank 21 and the amount of time that the developer was agitated in the developing tank 21 is determined. The target toner density T is calculated by the formula (2). One count of the initial toner density correction value corresponds to about 0.1% of the toner density of the developer, and a sign of “+” shows that the initial toner density is corrected in a direction to increase the toner density of the developer.

T=A+ΔN (2)

A: a reference toner density

ΔN: an initial toner density correction value

<Step b14>

The current toner density is compared with a value obtained by subtracting three counts from the target toner density T calculated at step b13. When the current toner density is not less than the value obtained by subtracting three counts from the target toner density T, the procedure proceeds to step b15, and when the current toner density is less than the value obtained by subtracting three counts from the target toner density T, the procedure proceeds to step b16.

<Step b16>

The toner replenishing mode is started to replenish toner. Although it is possible to replenish necessary amount of toner at a time, it is preferable to replenish separately a plurality of times. In the embodiment, the toner is replenished in two steps. By using the value obtained by subtracting three counts from the target toner density T to compare with the current toner density at step b14, it is possible to carry out the toner replenishment in two steps, resulting that no large amount of toner will be replenished to the developing tank 21 at a time. Hence, scattering of the toner because of uncharged toner can be prevented, and it is possible to form images having a constant image density more stably.

<Step b17>

The toner replenishment is carried out until the value of the current toner density becomes equal to or above the value obtained by subtracting three counts from the target toner density T.

<Step b18>

The toner replenishing mode is stopped to stop the toner replenishment.

<Step b19>

The developer agitation is carried out for thirty seconds. When the developer for replacement is stood for a long time, the electrical-charge amount of the toner decreases significantly and there is a risk that scattering of the toner is caused at the time of agitation, however, after inputting the developer for replacement to the developing device 200, by agitating in a state where the toner density is low, that is, the coverage ratio of the carrier by the toner is low, to increase the electrical-charge amount of the toner, it is possible to reduce scattering of the toner. As a result, it is possible to reproduce images having a constant image density more stably.

<Step b15>

The current toner density is compared with the target toner density T calculated at step b14. When the current toner density is not less than the target toner density T, the processing of initial toner density correction is completed. When the current toner density is less than the target toner density T, the procedure proceeds to step b20.

<Step b20>

The toner replenishing mode is started to replenish the toner.

<Step b21>

The toner replenishment is carried out until the value of the current toner density becomes equal to or above that of the target toner density T.

<Step b22>

The toner replenishing mode is stopped to stop the toner replenishment.

<Step b23>

The developer agitation is carried out for thirty seconds. Thereby, the processing of initial toner density correction is completed.

After completing the processing of initial toner density correction, image formation is started to be preformed using the image forming apparatus 100 shown in FIG. 1.

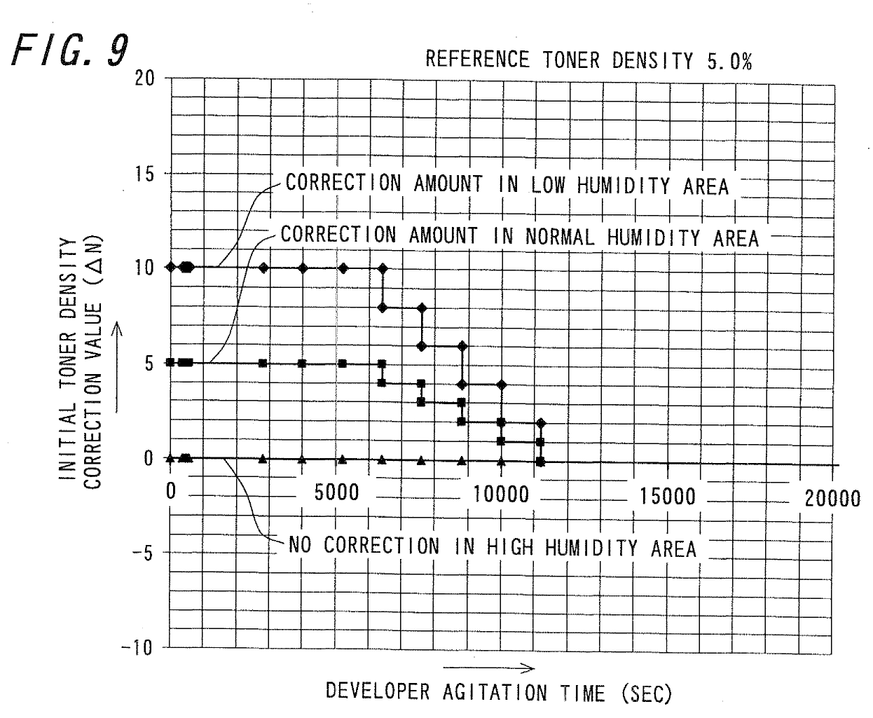

FIG. 9 is a graph showing transition of initial toner density correction amounts in each humidity area. Here, the reference toner density in the developer is 5.0%. The graph of FIG. 9 is created based on the tables of FIGS. 7 and 8. The graph of FIG. 9 shows that the correction amount in the low humidity area is greater than that in the normal humidity area, and no correction of the initial toner density is carried out in the high humidity area. Moreover, the graph shows that the correction amount of the initial toner density decreases as the agitation time of the developer in the developing tank becomes longer.

As described above, by carrying out processing of steps a1 to a4 or steps b11 to b23, it is possible to adjust to an optimum toner density of a two-component developer corresponding to the atmosphere humidity surrounding the developing tank. Hence, by providing the developing device of the invention in the image forming apparatus, it is possible to form images having a constant image density, even when the image forming apparatus is installed in the high humidity environment or in the low humidity environment. Moreover, since it is possible to prevent the carrier from being adhered to the photoreceptor drum, excellent images having no hollow defects can be formed stably.

### EXAMPLES

### Example 1

In the image forming apparatus 100 shown in FIG. 1, continuous printing test was conducted using a two-component developer. As a test paper, A4-sized electrophotographic recording mediums (multireceiver: manufactured by SHARP DOCUMENT SYSTEM CORPORATION) were used. The continuous printing test was conducted in the normal humidity environment where the temperature is 25° C. and the humidity is 60%.

Printing test for a text image in which the coverage of the print image formed on a sheet, that is, the coverage ratio by the toner in an image forming possible area is 6% was conducted for 50,000 (hereinafter abbreviated as “50 k”) sheets, and the image density is measured for each 5 k sheets of printing.

### Example 2

The continuous printing test was conducted in the similar way as that of the example 1, except for that the continuous printing test was conducted in the low humidity environment where the temperature is 25° C. and the humidity is 10%.

### Comparative Example 1

The continuous printing test was conducted in the similar way as that of the example 1, except for that the image forming apparatus 100 is provided with control software having no initial toner density correction control mode.

### Comparative Example 2

The continuous printing test was conducted in the similar way as that of the example 2, except for that the image forming apparatus 100 is provided with control software having no initial toner density correction control mode.

<Image Density Evaluation>

The image density was measured by printing a solid image (100% of density) having one side of 5 cm and using a reflection densitometer (manufactured by Macbes Co., Ltd.: PD918). The evaluation criteria conforms to the followings:

Good: Favorable. The image density is not less than 1.30 and fiber of a sheet is completely covered with the toner.

Not good: Not so favorable. The image density is from 1.20 to less than 1.30 and fiber of a sheet is appropriately covered with the toner to a certain extent.

Poor: Bad. The image density is less than 1.20 and the fiber of a sheet is not completely covered with the toner.

<Result>

Table 1 shows the result of the continuous printing test.

TABLE 1

| | | Initial | | | | | | | | | | | |
|---|---|---|---|---|---|---|---|---|---|---|---|---|---|
| | Humidity | toner density | At | | | | | | | | | | |
| | (%) | correction mode | start-up | 5kth | 10kth | 15kth | 20kth | 25kth | 30kth | 35kth | 40kth | 45kth | 50kth |
| Example 1 | 60 | Have | Good | Good | Good | Good | Good | Good | Good | Good | Good | Good | Good |
| Example 2 | 10 | Have | Good | Good | Good | Good | Good | Good | Good | Good | Good | Good | Good |
| Comparative | 60 | None | Good | Poor | Not | Not | Good | Good | Good | Good | Good | Good | Good |
| Example 1 | | | | | good | good | | | | | | | |
| Comparative | 10 | None | Good | Poor | Poor | Not | Not | Good | Good | Good | Good | Good | Good |
| Example 2 | | | | | | good | good | | | | | | |

According to the result of the continuous printing test shown in Table 1, in images formed by the image forming apparatus 100 having the initial toner density correction mode like in the examples 1 and 2, enough image density was obtained in the evaluation of the image density for each 5 k sheets from first to 50 kth sheets, even in the normal humidity environment where the temperature is 25° C. and the humidity is 60% and in the low humidity environment where the temperature is 25° C. and the humidity is 10%.

On the other hand, it was found that the image density from 5 kth to 15 kth sheets was lowered in the comparative example 1 where images were formed by the image forming apparatus 100 having no initial toner density correction mode in the normal humidity environment where the temperature is 25° C. and the humidity is 60%. Moreover, it was found that the image density from 5 kth to 20 kth sheets was lowered in the comparative example 2 where images were formed by the image forming apparatus 100 having no initial toner density correction mode in the low humidity environment where the temperature is 25° C. and the humidity is 10%.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A developing device, comprising:
a developing tank for accommodating therein developer composed of toner and carrier;
a humidity detecting section for detecting a humidity of surrounding air in a vicinity of the developing tank;
a toner replenishing section for replenishing toner to the developing tank;
an agitating section for agitating developer; and
a determination section for determining whether toner replenishment is necessary or not,
wherein after developer is replaced, the humidity detecting section detects the humidity before starting a development operation,
based on the detected humidity, the determination section determines whether toner replenishment is necessary or not, and
when the determination section determines that toner replenishment is necessary, the toner replenishing section carries out toner replenishment.

2. The developing device of claim 1, wherein the determination section carries out determination after developer is replaced and developer is agitated by the agitating section.

3. The developing device of claim 1, wherein when the determination section determines to replenish toner, the toner replenishing section replenishes toner separately a plurality of times.

4. A developing device, comprising:
a developing tank for accommodating therein developer composed of toner and carrier;
a humidity detecting section for detecting a humidity of surrounding air in a vicinity of the developing tank;
a density detecting section for detecting a toner density in the developing tank;
a toner replenishing section for replenishing toner to the developing tank;
an agitating section for agitating developer; and
a determination section for determining whether toner replenishment is necessary or not,
wherein after developer is replaced, the humidity detecting section and the density detecting section detect the humidity and the toner density before starting a development operation,
based on the detected humidity and toner density, the determination section determines whether toner replenishment is necessary or not, and
when the determination section determines that toner replenishment is necessary, the toner replenishing section carries out toner replenishment.

5. The developing device of claim 4, wherein the density detecting section detects the density after replaced developer is agitated until an electrical-charge amount of toner thereof attains a saturated amount.

6. An image forming apparatus provided with the developing device of claim 1.

7. An image forming apparatus provided with the developing device of claim 4.
